(19) United States
(12) Patent Application Publication
(10) Pub. No.: US 2026/0289448 A1
(43) Pub. Date: Sep. 24, 2026

(54) SYSTEMS AND METHODS OF DEPLOYING NEURAL NETWORKS FOR CREW ALLOCATIONS

(71) Applicant: GRID COOPERATOR LLC, Willowbrook, IL (US)

(72) Inventors: Shikhar Pandey, Forest Park, IL (US); Keith D'Souza, Chicago, IL (US)

(21) Appl. No.: 19/571,950

(22) Filed: Mar. 19, 2026

Related U.S. Application Data
(60) Provisional application No. 63/774,895, filed on Mar. 20, 2025.

(51) Int. Cl. G06Q 10/0631

(52) U.S. Cl. CPC G06Q 10/063118

(57) ABSTRACT

In some embodiments, systems and methods for preplacing crews in anticipation of at least one outage ticket based on an objective can aid in reducing downtime from the outage. In some embodiments, such preplacement strategies leverage historical outage data, weather forecasting, and machine learning-based predictions to position crews at optimal locations before outages occur. In some embodiments, this proactive approach can minimize response times and improve overall restoration efficiency. In some embodiments, systems and methods for determining real-time crew dispatch for at least one crew in response to at least one outage ticket can also aid in reducing downtime from the outage. In some embodiments, real-time dispatch systems dynamically assign crews based on outage prioritization, crew availability, and predicted outage types, enabling adaptive resource allocation as conditions evolve during an outage event.

### CROSS-REFERENCE TO RELATED APPLICATION(S)

This application claims priority benefits from U.S. application No. 63/774,895 filed on Mar. 20, 2025, entitled “Systems and Methods of Deploying Neural Networks for Crew Allocations”. The '895 application is hereby incorporated by reference herein in its entirety.

### BACKGROUND OF THE INVENTION

The present subject matter relates to systems and methods for dispatching one or more crews with different work types and abilities (for example construction crews, wire watchers, vegetation crews, and dispatchers) during utility outages and/or similar situations.

Outages can result from a variety of causes, including, but not limited to, severe weather conditions, technical failures, or unexpected system overloads.

In the utility and infrastructure sectors, effective crew deployment can help minimize, or at least reduce, downtime after an outage. Proper crew placement can reduce operational costs, improve response times, reduce customer outage duration, and/or enhance overall service reliability.

Traditionally crew dispatch decisions have been made based on manual assessments and/or basic rule-based systems, that can lead to inefficiencies such as overstaffing, understaffing, and/or misallocation of resources. Additionally, static crew deployment strategies fail to account for dynamic factors like evolving weather conditions, historical outage trends, and/or real-time incident reports.

### SUMMARY OF THE INVENTION

Methods, systems, and methodologies of crew dispatching are disclosed. In some embodiments, these methods, systems, and methodologies leverage historical data and/or real-time reports to produce outage predictions and suggest crew preplacements and/or deployments.

There are several aspects of the present subject matter which can be embodied separately or together in the devices and systems described below. These aspects can be employed alone or in combination with other aspects of the subject matter described herein, and the description of these aspects together is not intended to preclude the use of these aspects separately or the claiming of such aspects separately or in different combinations.

In some embodiments, a system for determining crew preplacement for at least one crew in response to at least one outage ticket based on an objective is provided.

In some embodiments, the system comprises a computing system including a non-transitory memory storing executable instructions and a processor coupled to the non-transitory memory. In some embodiments, the processor executes the executable instructions determining crew preplacement. In some embodiments, the processor is configured to acquire and analyze an amount of historical outage data associated with a geographical region and outage type; compute a machine learning-based metric and outage prediction associated with the geographical region; and generate an initial crew preplacement suggestion based on the machine learning-based metric and the outage prediction associated with the geographical region. In some embodiments, the processor is further configured to acquire first user input accepting the initial crew preplacement suggestion and terminate the crew preplacement if acceptance is acquired. In some embodiments, the processor is configured to acquire a second user input revising the objective if non-acceptance is acquired. In some embodiments, the processor is further configured to compute a second crew preplacement suggestion based on the revised objective. In some embodiments, the processor is also configured to acquire a third user input accepting the second crew preplacement suggestion and to iterate acquiring second and third user input and computing another crew preplacement suggestion. Lastly, the processor is configured to terminate the crew preplacement if acceptance of the other crew preplacement suggestion is acquired.

In some embodiments, a system for determines real-time crew dispatch for at least one crew in response to at least one outage ticket. In some embodiments, the crew can be one of several crew types including, but not limited to, patrollers/damage assessors, wire watchers, vegetation crews, and/or construction crews. In some embodiments, the system comprises at least one portable tracking device. In some embodiments, the at least one portable tracking device is carried by at least one crew. In some embodiments, the portable tracking device comprises a wireless communication interface configured to transmit outage data. In some embodiments, the system comprises a computing system comprising a non-transitory memory storing executable instructions, a wireless transceiver connecting with the wireless communication interface in the at least one portable tracking device, and a processor coupled to the wireless transceiver and the non-transitory memory, wherein the processor, executes the executable instructions determining crew dispatch to acquire and analyze outage data associated with the at least one outage ticket. In some embodiments, the outage data includes at least one of outage location and customer count. In some embodiments, the system sorts and prioritizes the at least one outage ticket based on the highest number of customer count. In some embodiments, the system acquires historical outage data to inform probability of the outage type associated with outage location associated with the at least one outage ticket and uses a machine learning model to iteratively assign the at least one crew with the at least one outage ticket based on the prioritization and an objective.

In some embodiments, the processor is further configured to dispatch the at least one crew according to an assignment based on the probability of requiring a crew; wherein the probability of requiring a crew includes at least one of the probability requiring a construction crew and the probability of requiring vegetation crew. In some embodiments, the processor is configured to compare the probability of requiring a construction crew with a first predetermined threshold, dispatch the construction crew to the outage location if the probability of requiring construction crew greater than the first predetermined threshold; compare the probability of requiring a vegetation crew with a second predetermined threshold, and dispatch the vegetation crew to the outage location if the probability of requiring a vegetation crew is greater than the second predetermined threshold.

In some embodiments, the processor is further configured to assign a wire-watcher with the at least one outage ticket and dispatch the wire watcher to the outage location. In some embodiments, the system is configured to dispatch a patroller to verify the site condition associated with the outage location if the probability of requiring a construction crew is below the first predetermined threshold or the probability of requiring a vegetation crew is below a second predetermined threshold.

In some embodiments, the system determines if assigning the at least one crew with the at least one outage ticket is correct or incorrect and then determines whether the at least one crew type proceeded with the restoration or the at least one crew updated the outage data via the at least one portable tracking device. In some embodiments, the processor is configured to transmit the updated outage data to the system via the at least one portable tracking device and repeat steps from prioritizing the outage ticket to determining the correctness of the outage ticket assignment with the updated outage data. In some embodiments, the processor is configured to update status of the at least one outage ticket from open to close after completing the outage restoration.

In some embodiments, a user interface application that is executed on a portable tracking device communicates with a computing system. In some embodiments, the computing system hosts the executable instructions for determining crew dispatch, a dispatcher monitors primary database storing the historical outage data and further processes the outage data. In some embodiments, the user interface application is configured to receive the crew-outage ticket assignment derived from the computing system, acquire and assess the outage data collected on site from the at least one crew, transmit the on-site outage data to the computing system for further processing by the dispatcher, and/or adjust the crew-outage ticket assignment based on the on-site outage data processed by the dispatcher.

In some embodiments, methods and systems for the preplacement of at least one crew in response to at least one outage ticket based on an objective, include acquiring and analyzing historical outage data associated with a geographical region and outage type. In some embodiments, the methods and systems include computing a machine learning-based metric and outage prediction associated with the geographical region, generating an initial crew preplacement suggestion based on the machine learning-based metric and the outage prediction associated with the geographical region, acquiring first user input accepting the initial crew preplacement suggestion, terminating the crew preplacement if acceptance is acquired, acquiring second user input revising the objective if non-acceptance is acquired, computing another crew preplacement suggestion based on the revised objective, and/or acquiring third user input accepting the another crew preplacement suggestion. In some embodiments, the methods and systems include iterating acquiring a second user input, computing another crew preplacement suggestion and acquiring a third user input if any non-acceptance is acquired. In some embodiments, the methods and systems include terminating the crew preplacement if acceptance of the another crew preplacement suggestion is acquired.

In some embodiments, methods and systems for dispatching a crew in real-time in response to at least one outage ticket, includes acquiring and analyzing outage data associated with the at least one outage ticket. In some embodiments, the outage data includes at least one of outage location and customer count. In some embodiments, the methods and systems involve sorting and prioritizing the at least one outage ticket based on highest number of customer count. In some embodiments, the methods and systems involve acquiring historical outage data to predict the probability of the outage type associated with outage location associated with the at least one outage ticket. In some embodiments, the methods and systems involve using a machine learning model to iteratively assign the at least one crew with the at least one outage ticket based on the prioritization and an objective. In some embodiments, the methods and systems involve dispatching the at least one crew according to the assignment based on the probability of requiring a crew; wherein the probability requiring crew including at least one of probability requiring construction crew and probability of requiring a vegetation crew; comparing the probability of requiring a construction crew with a first predetermined threshold; dispatching the construction crew to the outage location if the probability of requiring a construction crew is greater than the first predetermined threshold; comparing the probability of requiring a vegetation crew with a second predetermined threshold; dispatching the vegetation crew to the outage location if the probability of requiring a vegetation crew is greater than the second predetermined threshold; assigning a wire watcher with the at least one outage ticket and dispatch the wire watcher to the outage location; and/or dispatching a patroller to verify site condition associated with the outage location if the probability of requiring a construction crew is below the first predetermined threshold and/or the probability of requiring a vegetation crew is below a second predetermined threshold. In some embodiments, the systems and methods involve determining if assigning the at least one crew with the at least one outage ticket is correct or incorrect and proceeding with having the at least one crew to restore the outage or update the outage data via the at least one portable tracking device. In some embodiments, the systems and methods include transmitting the updated outage data to the system and repeating steps from prioritizing the outage ticket to determining the correctness of the outage ticket assignment with the updated outage data. In some embodiments, the systems and methods include updating the status of the at least one outage ticket from open to close after completing the outage restoration.

In some embodiments, the processor can determine restoration time for the outage ticket associated with the outage type; compute a ratio of vegetation-related outages to non-vegetation-related outages for the outage type associated with the geographical region; compute a ratio of wire-down events to total outages for the outage type associated with the geographical region; and/or compute an average restoration time for the outage ticket based on the historical outage data associated with the geographical region.

In some embodiments, the objective can be an estimated time of restoration. The historical outage data can include a historical outage location, a historical outage type, a historical restoration time, a historical ticket data, and/or a historical crew-specified feature. The historical crew-specified feature may include a crew type, a crew location, and/or a crew staffing protocol.

In some embodiments, the outage data can include the probability of the outage type, a restoration time, the crew type and/or a crew location associated with the outage ticket. The historical outage data may include a historical outage location, a historical outage type, a historical restoration time and/or the probability of requiring the crew type. The first predetermined threshold may be based on a historical outage type associated with the outage location defined in the historical outage data.

The systems and methods disclosed herein may provide improved efficiency in crew placement and dispatch for outage response, potentially reducing restoration times and improving overall service reliability.

### BRIEF DESCRIPTION OF THE DRAWINGS

FIG. 1 illustrates an overview of a typical existing system for crew deployment in response to a utility outage.

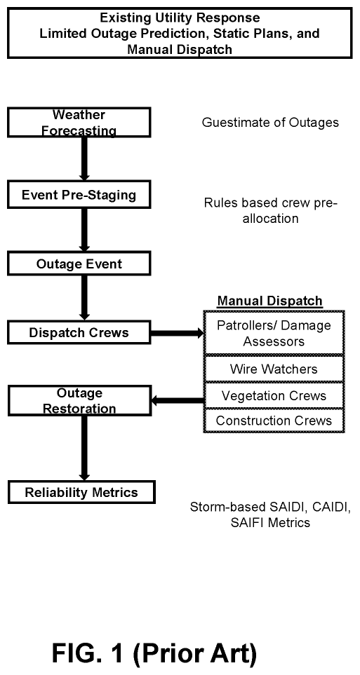

FIG. 2 illustrates an overview of exemplary system for crew deployment in response to a utility outage using an AI model with a hybrid data source.

FIG. 3 illustrates an exemplary embodiment of an AI-powered network computing system for determining crew preplacement.

FIG. 4 illustrates an exemplary embodiment of an algorithm for determining crew preplacement.

FIG. 5 illustrates an exemplary embodiment of an AI-powered network computing system topologies for determining crew dispatch with real-time integration.

FIG. 6 illustrates an exemplary embodiment of an algorithm for determining crew deployment with real-time integration.

FIG. 7 illustrates an exemplary embodiment of a user interface application for crew communication.

### DETAILED DESCRIPTION OF ILLUSTRATIVE EMBODIMENT(S)

The embodiments disclosed herein are for the purpose of providing descriptions of the present subject matter, and it is understood that the subject matter can be embodied in various other forms and combinations not shown in detail. Therefore, specific designs and features disclosed herein are not to be interpreted as limiting the subject matter as defined in the accompanying claims.

The term “dynamic” and “dynamically” as used herein refers to actions performed during execution of the neural network training application.

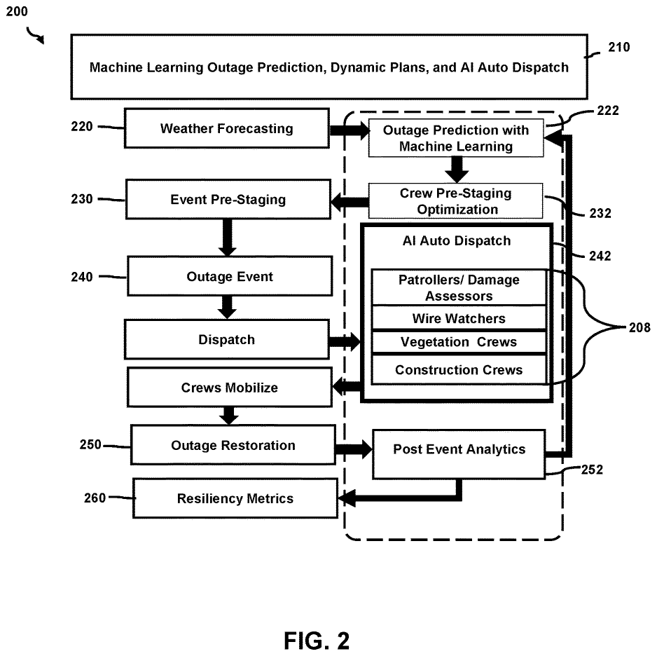

FIG. 2 depicts system 200 which leverages machine learning, dynamic planning, and/or AI dispatch to enhance outage prediction, crew management, and/or restoration efforts (block 210). In some embodiments, system 200 begins with weather forecasting (block 220). In some embodiments, weather forecasting helps anticipate potential outages by analyzing meteorological data such as storm trajectories, wind speeds, precipitation levels, and temperature fluctuations that historically correlate with utility infrastructure failures. In some embodiments, this weather data is integrated with geographic information systems (GIS) to identify vulnerable areas within the utility's service territory. In some embodiments, weather forecasting enables event pre-staging and/or preplacement to position crews proactively (block 230). In some embodiments, pre-staging involves strategically positioning crews, equipment, and materials at locations determined based on predicted outage density and severity.

In some embodiments, weather data can be obtained from various sources including national meteorological services, commercial weather providers, satellite imagery systems, and/or local weather monitoring stations deployed throughout the utility's service territory. In some embodiments, the system integrates multiple weather data feeds to improve forecast accuracy and provide redundancy in case of data source unavailability. In some embodiments, weather data sources can include radar data for precipitation tracking, lightning detection networks for storm activity monitoring, and/or atmospheric pressure sensors for predicting wind patterns. In some embodiments, the system can incorporate proprietary weather models developed specifically for utility applications that account for localized terrain effects and microclimate variations within the service area.

In some embodiments, weather forecasting can utilize ensemble modeling techniques that combine multiple forecast models to generate probabilistic predictions of severe weather events. In some embodiments, the system can process weather data at various temporal resolutions, ranging from hourly forecasts for immediate operational planning to multi-day forecasts for resource mobilization and crew scheduling. In some embodiments, weather forecasting can incorporate historical weather-to-outage correlation data to translate meteorological predictions into expected outage counts and geographic distributions. In some embodiments, the system can generate heat maps overlaying predicted weather severity with infrastructure vulnerability assessments to identify high-risk zones requiring priority crew preplacement.

In some embodiments, using historical and/or real-time data, machine learning predicts outages (block 222). In some embodiments, the machine learning models analyze patterns from past outage events, including correlations between specific weather conditions and outage types, geographic factors such as vegetation density and infrastructure age, and temporal patterns such as seasonal variations in outage frequency. In some embodiments, this prediction is used to determine crew pre-staging (block 232). In some embodiments, crew pre-staging decisions incorporate factors such as estimated travel times to predicted outage locations, crew specializations required for anticipated outage types, and resource availability constraints.

In some embodiments, when an outage occurs (block 240), AI dispatch system (block 242) assigns one or more crews to perform certain tasks (block 208). In some embodiments, the AI dispatch system evaluates multiple factors including outage priority based on customer impact, crew proximity to outage locations, crew skill sets relative to predicted outage types, and overall optimization objectives such as minimizing total restoration time or reducing customer minutes interrupted. In some embodiments, crews can include, but are not limited to, patrollers/damage assessors, wire watchers, vegetation crews, and/or construction crews. In some embodiments, patrollers/damage assessors are responsible for initial site inspection and outage classification. In some embodiments, wire watchers monitor downed power lines to ensure public safety until repair crews arrive. In some embodiments, vegetation crews address outages caused by fallen trees, branches, or other vegetation interference with utility infrastructure. In some embodiments, construction crews perform repairs to damaged equipment such as transformers, poles, conductors, and/or other electrical infrastructure components.

In some embodiments, once dispatched, these crews work on outage restoration (block 250), while system 200 gathers post-storm analytics (block 252) to assess performance and refine future strategies. In some embodiments, post-storm analytics include metrics such as actual versus predicted outage counts, crew utilization rates, average restoration times by outage type, and geographic distribution of restoration efforts. In some embodiments, this data is fed back into the machine learning models to improve prediction accuracy for future events. In some embodiments, resilience metrics (block 260) measure the effectiveness of the response, continuously aiming to improve outage management. In some embodiments, resilience metrics can include Customer Average Interruption Duration Index (CAIDI), System Average Interruption Frequency Index (SAIFI), Customer Minutes Interrupted CMI, and restoration cost per customer. In at least some embodiments, the AI-driven approach enhances efficiency, accuracy, and/or response times in dealing with outages by enabling data-driven decision-making throughout the outage management lifecycle.

In some embodiments, the AI-driven approach described herein provides a technical improvement to utility infrastructure management systems by enabling automatic, proactive remediation of outage events. In some embodiments, unlike traditional crew dispatch systems that rely on manual dispatcher intervention for each decision, the system automatically analyzes incoming outage data, automatically classifies outage types based on historical patterns and real-time conditions, automatically prioritizes outages based on customer impact, and automatically generates crew dispatch assignments without requiring human intervention for routine decisions. In some embodiments, this automatic processing enables the system to respond to outage events in real time, reducing the delay inherent in manual dispatch processes. In some embodiments, the system can process multiple simultaneous outage reports, continuously update crew assignments as conditions evolve, and dynamically reallocate resources based on field updates, all without requiring a dispatcher to manually evaluate each decision. In some embodiments, this technical improvement to the utility infrastructure management system results in measurably reduced restoration times, improved crew utilization rates, and enhanced overall system responsiveness during outage events.

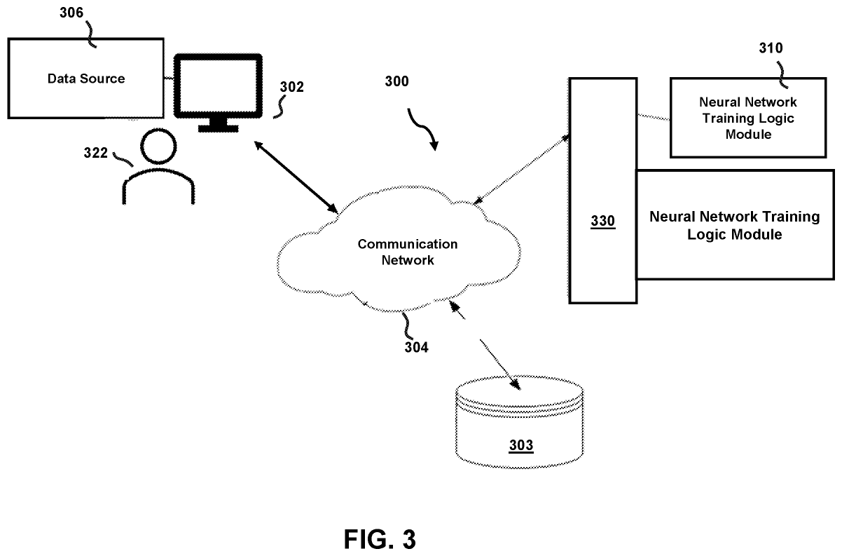

FIG. 3 illustrates an embodiment of system 300 including computing device 302 connected to a base machine learning (ML) module 310 hosted on server device 330. In at least some embodiments, the base ML module 310 is integrated with a neural network training subsystem designed to predict outage events and optimize, or at least improve, crew preplacement for at least one crew in response to at least one outage ticket.

In some embodiments, the neural network subsystem is a commercial solution, ready for integration into an existing dispatching system. In some embodiments, the neural network subsystem enhances the existing dispatching system by leveraging historical outage data for training. In some embodiments, the base ML module 310 processes historical outage data using a machine learning algorithm to generate outage predictions. In some embodiments, the base ML module 310 optimizes, or at least improves, crew pre-staging or preplacement plans for at least one crew in response to an outage ticket (i.e., a record or work order generated in response to a reported or detected utility outage that includes information such as outage location, affected customers, and/or outage status).

In some embodiments, these plans are based on specific objectives, such as, but not limited to, customer management index (CMI), estimated time of restoration (ETR), crew availability, and/or restoration cost analysis. In some embodiments, the base ML module 310 employs multiple machine learning-based computations including regression analysis, Chebyshev approximation, and/or DBSCAN clustering to estimate CMI and crew hours (CH), with final values computed by averaging the results from these algorithms.

In some embodiments, the base ML module 310 can connect via wired (e.g., Ethernet) or wireless (e.g., cloud-based) networks 304 to primary database 303 storing historical outage data available in a management system, such as Outage Management System (OMS). In some embodiments, the historical outage data are categorized by outage type and geographical region. In some embodiments, outage types can be categorized into predefined classes based on historical data, including but not limited to vegetation-related outages, wire-down events, construction-related outages, and other outage classifications. In some embodiments, the neural network subsystem in the base ML module 310 can be trained with a set of input data and machine learning metrics extracted from the input data in predicting outage. In some embodiments, the input data can include outage records from database 303 and/or crew-specific data stored in the data source 306 of computing device 302. In some embodiments, historical outage data from database 303 can include details from past outage events, such as outage location, customer impact (such as the number of affected customers), outage type (such as but not limited to, equipment failure, weather-related, vegetation interference, wire-down incidents, or scheduled maintenance), restoration time, outage ticket creation time, and/or correlations between weather factors and outage occurrences. In some embodiments, crew-specific data can include crew type (such as patrollers/damage assessors, wire watchers, vegetation crews, and/or construction crews), crew location, staffing protocols, shift schedules, and/or availability. In some embodiments, these datasets enable the neural network to enhance outage prediction accuracy and optimize, or at least improve, resource deployment.

In some embodiments, the ML module 310 derives machine learning-based metrics from the historical data, including the average distance between outages, the correlation between weather factors, outage type and crew type, the average outage resolution time based on crew type, outage type ratios representing the proportion of different outage types, and/or the relationship between historical crew staffing levels and total outage restoration time.

In some embodiments, outage data source 306 can be processed in a software application embedded in computing device 302. In some embodiments, the software application can be a web-based application program that is executed on computing device 302. In some embodiments, computing device 302 can be used to access or acquire historical outage data, for instance, by a dispatcher 322 at dispatching center. In some embodiments, the software application provides an interface through which dispatcher 322 can view outage predictions, review crew preplacement (i.e., the strategic positioning of crews at designated locations in anticipation of predicted outages before the outages actually occur) suggestions, and/or input operational parameters to refine the crew allocation process.

In some embodiments, server 330 is in communication via communication network 304 with computing device 302 for determining crew preplacement plan. In some embodiments, database 303 stores historical outage data in the past storm event accessible to data source 306 via a software application. In some embodiments, database 303 is communicatively accessible to server 330 and/or to computing device 302. In some embodiments, the communication network 304 facilitates real-time data exchange between the server 330, computing device 302, and/or database 303, enabling continuous updates to outage predictions and crew preplacement recommendations as new data becomes available.

In some embodiments, computing device 302 accesses and processes both historical data from the OMS database 303 and real-time inputs from the at least one crew. In some embodiments, computing device 302 can include one or more hardware components, including, but not limited to, a non-transitory memory (not shown) storing executable instructions, a processor (not shown) for execution, and/or input interfaces through which the dispatcher 322 controls the process. In some embodiments, a keyboard allows operators to enter various parameters such as outage-specific data, crew-specific data, targeted crew working hours, and/or a desired Customer Management Index (CMI). In some embodiments, the processor executes the executable instructions to acquire and analyze historical outage data associated with a geographical region and outage type, compute machine learning-based metrics and outage predictions, and generate crew preplacement suggestions based on these computations. In some embodiments, the system integrates automation while enabling user interaction to dynamically refine the crew preplacement plan, allowing users to input adjustments to fine-tune restoration efforts and ensure crew allocation aligns with operational objectives such as desired outage restoration times and crew availability.

In some embodiments, computing device 302 can be implemented as a desktop computer, a workstation, a server, a laptop, a tablet, or any other suitable computing platform capable of executing the software application and communicating with server 330 and database 303. In some embodiments, computing device 302 includes a central processing unit (CPU) comprising one or more processor cores configured to execute instructions stored in memory. In some embodiments, the CPU can be a multi-core processor capable of parallel processing to handle multiple computational tasks simultaneously, such as processing outage data while generating crew preplacement suggestions. In some embodiments, computing device 302 includes random access memory (RAM) for temporary data storage during program execution and non-volatile storage such as solid-state drives (SSDs) or hard disk drives (HDDs) for persistent data storage. In some embodiments, computing device 302 includes one or more network interface controllers (NICs) supporting wired connections such as Ethernet and/or wireless connections such as Wi-Fi to facilitate communication over communication network 304. In some embodiments, the system architecture of computing device 302 follows a client-server model where computing device 302 acts as a client that sends requests to server 330 for machine learning computations and receives crew preplacement suggestions in response. In some embodiments, computing device 302 includes a local cache for storing frequently accessed data from database 303 to reduce network latency and improve response times for dispatcher 322.

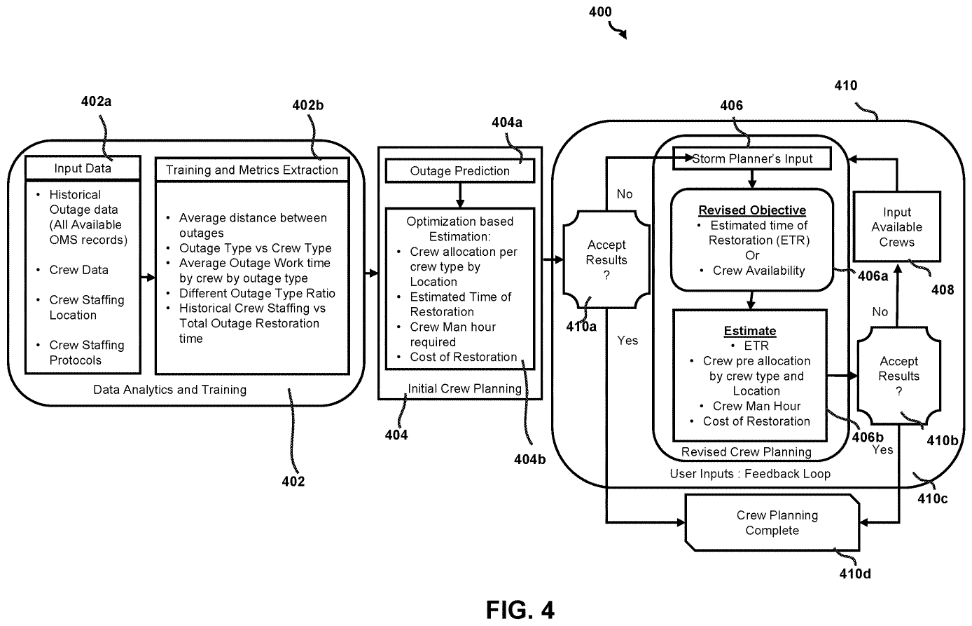

In some embodiments, such as illustrated in FIG. 4, system 300 is configured to acquire and analyze input outage data from past outage events 402a including historical outage data associated with a geographical region and/or an outage type. In some embodiments, system 300 is further configured to use the input data from past outage events (block 402a) and/or crew specific data to derive machine learning-based metrics (block 402b), to generate an outage prediction (block 404a) via crew preplacement algorithm 400. In some embodiments, this prediction is then used to design an initial crew preplacement plan (block 404). In some embodiments, the initial crew preplacement plan specifies the strategic positioning of crews at designated locations in anticipation of predicted outages, including crew type assignments, geographic deployment zones, and resource allocation based on the computed outage predictions.

In some embodiments, the ML-based metrics (block 402b) can include the average distance between outages, the correlation between weather factors, outage type and crew type, and/or the average outage resolution time based on crew type. Crew type can include, but is not limited to, patrollers/damage assessors, wire watchers, vegetation crews, and/or construction crews. In some embodiments, the correlation between weather factors and outage type can be computed by analyzing historical data to identify patterns such as the relationship between wind speed thresholds and vegetation-related outages, or the correlation between ice accumulation and wire-down events.

In some embodiments, additional metrics can include outage type ratios, the proportion of different outage types, and/or the relationship between historical crew staffing levels and total outage restoration time. In some embodiments, these additional metrics enable the system to balance crew allocation across different outage categories and optimize staffing levels to achieve target restoration objectives.

In some embodiments, the algorithm can be broken down into several steps.

In some embodiments, Step 1 involves utilizing Historical Outage Data for a Geographical Region. In some embodiments, this data includes the Time Taken to Restore Each Outage Type. In some embodiments, the historical outage data is retrieved from database 303, which stores records from past storm events accessible via the OMS or similar management system. In some embodiments, the geographical region can be subdivided into zones or service territories to enable more granular analysis and prediction.

As illustrated in blocks 402 and 404 a subset of these metrics (block 402b) can be derived from historical restoration times recorded from data for past outage events 402a. The restoration time for each outage type is represented as

$$[ {T}_{r}^{o} ] ,$$

where

$$‘ {T}_{r}^{o} ’$$

is a time array extracted from sorting the storm type in past outage events 402a based on outage type o.

$$‘ {T}_{r}^{o} ’$$

is a subset of the ML metrics which can be used for training the neural network in predicting outages (block 404a). In some embodiments, the time array

$${T}_{r}^{o}$$

contains individual restoration time values for each historical outage of type o, enabling statistical analysis such as mean, median, and variance calculations. In some embodiments, the outage type o can be one of vegetation (Veg), wire down, construction, or other classifications as defined in the system. Examples of computation of the ML-based metrics are described as follows.

In some embodiments, outage types can be categorized into predefined classes based on historical data, including but not limited to:

$$Outage type ∈ \{ Veg , wire down , construction , others , etc \}$$

In some embodiments, Outage Type Ratios can be used for predictive analysis. For example the Ratio of Vegetation-Related Outages to Non-Vegetation Outages can be calculated as:

$$\frac{[ {O}_{Predicted}^{Veg} ]}{[ {O}_{Predicted}^{Const} ]} where [ {O}_{Predicted}^{Veg} ]$$

represents the predicted number of vegetation-related outages, and

$$[ {O}_{Predicted}^{Const} ]$$

represents the predicted number of construction-related outages.

Similarly the Ratio of Wire Down Outages to Total Outages by Storm Type can be calculated as:

$$\frac{[ {O}_{Predicted}^{Wire} ]}{[ {O}_{Predicted}^{Total} ]} where [ {O}_{Predicted}^{Wire} ]$$

represents predicted wire-down outages, and

$$[ {O}_{Predicted}^{Total} ]$$

represents the total predicted outages for a given storm event.

In some embodiments, comparing the Historical Metrics for Customer Outages vs. CMI vs. crew hours (CH) can be used for predictive analysis.

Another key metric integrates the CMI with CH for historical outage-affected regions. This relationship is represented as

$$f ( {Cust}_{bin}^{by Outage type} ) = Array \{ CMI , CH \} \qquad Equation 1$$

$$where {Cust}_{bin}^{by Outage type}$$

is defined as Customer Outage Bin by outage type.

In some embodiments, system 300 assess total travel time for each crew within a given geographical region by considering the time required to reach outage locations. Using a Traveling Salesman Problem model in conjunction with an outage heatmap, in some embodiments, system 300 optimizes, or at least improves, crew routing to minimize travel distances, prioritize high-impact outage areas, enhance dispatch efficiency, and reduce overall response and restoration times.

In some embodiments, Step 2 of the algorithm involves predicting Outage Count and Customer Impact. In some embodiments, ML module 310 predicts the total outage count (block 404a) in FIG. 4 for a geographical region using the formula

$${O}^{Total} = {\sum }_{region = 1}^{n} {Outage}_{region} \qquad Equation 2$$

In some embodiments, ML module 310 estimates the number of affected customers by outage type across different regions, represented as

$${Cust}_{bin} = {\sum }_{region = 1}^{n} {Cust}_{region} \qquad Equation 3$$

In some embodiments, these predictions support emergency preparedness by providing insights into the total number of storm-related outages, enabling utility dispatchers 322 to determine the number of crews needed for restoration based on outage type. In some embodiments, spatial distribution predictions help dispatchers 322 strategically pre-position crews before a storm, ensuring efficient response and restoration efforts.

In some embodiments, Step 3 of the algorithm involves estimating CMI and CH using one or more algorithms. In some embodiments, system 300 integrates machine learning models to optimize or at least improve crew preplacement by considering outage predictions (block 404) and key operational metrics (block 402b). By automating the crew allocation process and leveraging historical outage patterns, system 300 enhances response efficiency, reduces restoration costs, and/or minimizes, or at least reduces downtime for affected customers. In doing so, system 300 utilizes outage prediction model 404a and historical outage (restoration) data to compute a crew preplacement suggestion including, but not limited to, the CMI, estimated CH, and estimated restoration cost (block 404b)—to determine restoration efforts.

In some embodiments, Function ƒ(Cust_{bin}) represents an array containing CMI and CH, derived from using three machine-learning based computations:
1. Regression Analysis (R1 {CMI, CH})
2. Chebyshev Approximation (C1 {CMI, CHI})
3. DBSCAN Clustering (D1 {CMI, CH}).

Each algorithm independently estimates CMI and CH, and the final values are computed by averaging the results:

$$\{ CMI , Crew Hours \} = \frac{R 1 + C 1 + D 1}{3} \qquad Equation 4$$

where CMI is defined as the product of estimated restoration time (ETR) and customer count as follows:

$$CMI = {\sum }_{i = 1}^{total customer outage} {ETR}_{i} \times Customer {Count}_{i} \qquad Equation 5$$

where ETR is estimated time of restoration (in minutes) and Customer count is number of customers affected within the given customer bin.

Crew Hours (CH) refers to the estimated workforce effort required for restoration, derived from historical staffing and restoration data.

To improve the accuracy of crew preplacement plan, system 300 can also consider various predictive metrics, including but not limited to:
Average Distance Between Outages (determine crew dispatch locations);
Outage Type vs. Crew Type Mapping (assigning the crew types based on outage classification);
Average Outage Work Time by Crew Type (patrollers/damage assessors, wire watcher, vegetation crews, and construction crews);
Outage Type Ratio (proportions of different outage types in the geographical region affected by the outage); and/or
Historical Crew Staffing vs. Total Restoration Time.

In some embodiments, system 300 then predicts outage occurrences based on historical data, allowing the crews to be pre-positioned before an event occurs. In some embodiments, crew preplacement suggestion 404b can include:
ETR;
CH;
Crew Allocation Per Crew Type—assigns/preplaces specific crews (e.g., vegetation teams, line workers) based on outage severity; and/or
Restoration Cost Analysis—calculates expected costs based on CH and resource utilization.

In some embodiments, system 300 then determines the number of personnel for restoration. In some embodiments, system 300 prompts the user to input whether the initial crew preplacement suggestion is acceptable (block 410a). If it is acceptable, the system proceeds with the crew pre-positioning planning as determined. Otherwise, the user is prompted to input an objective, for example a desired CMI (blocks 406a, 406b), to recompute the crew preplacement suggestion. In some embodiments, the recomputation process leverages the machine learning-based metrics derived from historical outage data, including the average distance between outages, outage type ratios, and the relationship between historical crew staffing levels and total outage restoration time, to generate a revised crew preplacement plan that aligns with the user-specified CMI target.

In some embodiments, system 300 integrates automation while enabling user interaction to dynamically refine the crew preplacement plan (block 410). In some embodiments, users can input adjustments (block 408) to fine-tune restoration efforts, ensuring crew allocation aligns with operational objectives (block 406b). In some embodiments, these objectives can include desired outage restoration times and crew availability, which can be qualitatively characterized by attributes defined as follows. In some embodiments, desired outage restoration times can be expressed as target ETR values for specific outage types or geographic regions, while crew availability can be characterized by factors such as the number of available crews by type (patrollers/damage assessors, wire watchers, vegetation crews, and construction crews), shift schedules, and geographic distribution of crew staging locations. In some embodiments, the system balances these operational objectives against predicted outage severity and customer impact to generate crew preplacement suggestions that optimize, or at least improve, restoration efficiency while respecting resource constraints.

In some embodiments, Step 4 of the algorithm involves obtaining user input for an initial crew preplacement suggestion. In some embodiments, at this stage, the user defines a target CMI value. The system utilizes the customer outage bins (Cust_{bin}) and the established data model to estimate the required CH needed to achieve the desired CMI.

For example, in some embodiments, the user is prompted to input the desired CMI:

$$f ( {Cust}_{b i n} ) = Array \{ CMI , CH \} \qquad Equation 6$$

The function ƒ (Cust_{bin}) represents a mapping of customer bins to an array containing two key values: CMI and CH. Each customer bin (Cust_{bin}) is defined as a grouping of customers based on outage characteristics (e.g., location, severity, historical data). In at least some embodiments, function ƒ(Cust_{bin}) stores the computed values in an array format:

$$f ( {Cust}_{bin} ) = [ \begin{matrix}{CMI}_{1} , {CH}_{1} \\ {CMI}_{2} , {CH}_{2} \\ {CMI}_{3} , {CH}_{3}\end{matrix} ] \qquad Equation 7$$

where each row represents a customer bin; the first column contains CMI values and the second column contains the corresponding CH.

If the estimated CH are accepted (block 410b), the process concludes (410d). If the estimated CH are not acceptable (block 410b), the user manually inputs available crew hours (block 406) instead and the system proceeds to the next step.

In some embodiments, Step 5 of the algorithm involves an iterative adjustment between CH and CMI. In some embodiments, once the system generates the initial crew preplacement suggestion (block 404b), it requests user confirmation by an interactive feedback loop (block 410c) to ensure that the crew allocation is both data-driven and adaptable and optionally allows for real-time adjustments based on operational constraints and user expertise.

In some embodiments, the interactive feedback loop enables the system to learn from dispatcher decisions and improve future predictions. In some embodiments, when a dispatcher overrides the system's crew preplacement suggestion, the system records the override along with contextual information such as the original suggestion, the dispatcher's modification, the stated rationale (if provided), and the actual restoration outcomes that resulted from the override. In some embodiments, this override data is stored in database 303 and periodically analyzed to identify patterns where human expertise consistently outperforms the algorithmic suggestions.

In some embodiments, the feedback mechanism improves future predictions by incorporating dispatcher override data into the model retraining process. In some embodiments, the system identifies scenarios where overrides led to improved restoration outcomes, such as reduced CMI or faster restoration times, and adjusts the weighting of relevant features in the machine learning models accordingly. In some embodiments, if dispatchers consistently override suggestions for specific geographic regions, outage types, or weather conditions, the system can learn these preferences and incorporate them into subsequent predictions.

In some embodiments, the feedback mechanism provides a technical improvement to the functioning of the crew dispatch system itself. In some embodiments, by incorporating dispatcher override data and actual restoration outcomes into the model retraining process, the system's neural network weights and feature importance rankings are automatically adjusted to reflect real-world operational patterns. In some embodiments, this results in measurably improved prediction accuracy over successive training cycles, as evidenced by reduced deviation between predicted and actual CMI values, improved correlation between predicted and actual crew hour requirements, and increased first-time correct crew type assignment rates. In some embodiments, the technical improvement manifests in the system's ability to automatically adapt its dispatch algorithms to account for geographic variations, seasonal patterns, and evolving infrastructure conditions without requiring manual reconfiguration of system parameters. In some embodiments, this self-improving capability represents a technical advancement in utility outage management systems that enables progressively more efficient crew dispatch decisions over time.

In some embodiments, the data retention policy for model retraining cycles specifies how long historical data, including dispatcher overrides and restoration outcomes, is retained for training purposes. In some embodiments, the system retains detailed outage and override data for a configurable period, such as three to five years, to capture seasonal variations and infrequent storm patterns. In some embodiments, older data may be aggregated or weighted less heavily in the training process to prioritize more recent operational patterns while still preserving long-term trends.

In some embodiments, model retraining occurs at scheduled intervals, such as after each major storm event, quarterly, or annually, depending on the volume of new data and observed model performance degradation. In some embodiments, the retraining process evaluates model accuracy by comparing predicted CMI and CH values against actual restoration outcomes, and the system generates performance reports indicating whether the feedback-driven improvements have enhanced prediction accuracy over time.

In some embodiments, the interactive feedback loop (block 410c) includes the following:

If the user provides crew hour constraints, the system reverses the calculation:

$$f ( {Cust}_{b i n} ) = Array \{ CMI , Crew Hours \}$$

In some embodiments, the system estimates the achievable CMI based on the given CH. If the estimated CMI is acceptable (block 410b), the process concludes (block 410d). If the estimated CMI is not acceptable (block 410b), the user can adjust the CMI input (block 408) and repeat the process.

In some embodiments, the system iterates between Step 4 and Step 5 (block 410c) until the user confirms that both CMI and CH align with operational requirements and the objective(s).

Once the user accepts the estimated CMI and CH allocations, the system finalizes the crew preplacement (block 410d). At this point, the crew allocation plan is ready for execution, and the system can begin real-time monitoring and dispatch as weather conditions evolve.

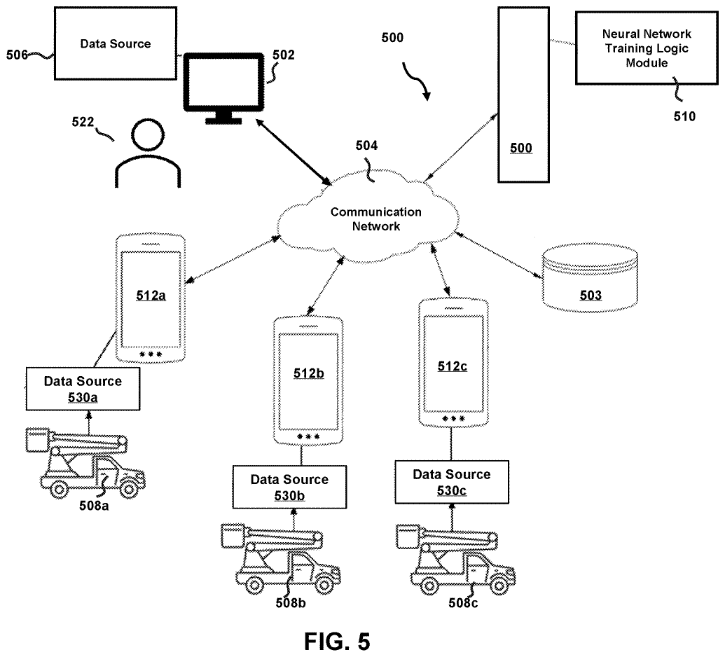

FIG. 5 depicts an embodiment of system 500, including computing device 502 that either incorporates or is linked to module 510 for training a neural network to optimize, or at least improve, real-time crew dispatch for at least one crew in response to at least one outage ticket. In some embodiments, computing device 502 is configured to access and analyze historical data in a primary database 503 available in a management system, such as OMS and/or real-time data. In some embodiments, system 500 extends the capabilities of the preplacement system described in FIG. 3 by incorporating real-time field data to enable dynamic crew dispatch decisions during active outage events.

In some embodiments, computing device 502 comprises hardware components, including but not limited to a non-transitory memory that stores executable instructions, a processor that executes these instructions, and/or input interfaces through which dispatcher 522 controls the process. In some embodiments, a keyboard allows operators to enter various parameters such as, but not limited to, outage-specific data, crew-specific data, targeted crew working hours, and a desired CMI. In some embodiments, computing device 502 can be implemented as a desktop computer, workstation, server, laptop, tablet, or any other suitable computing platform capable of executing the dispatch software application and communicating with server-hosted module 510 and database 503. In some embodiments, computing device 502 includes a central processing unit (CPU) comprising one or more processor cores configured to execute instructions stored in memory, with the CPU capable of parallel processing to handle multiple computational tasks simultaneously, such as processing real-time outage reports while generating crew dispatch assignments.

In some embodiments, the network structure between components such as computing device 502, OMS database 503, and machine learning module 510 in FIG. 5 remain the same as in FIG. 3. However, FIG. 5 introduces additional components such as at least one portable device 512a, 512b, and/or 512c carried by at least one crew 508a, 508b, and/or 508c, to allow integration of real-time data source 530a, 530b, and/or 530c from the job site to the automatic dispatch system 500. In some embodiments, portable tracking devices 512a, 512b, and/or 512c can include smartphones, tablets, ruggedized mobile computers, and/or other handheld devices equipped with wireless communication interfaces such as cellular (4G/5G), Wi-Fi, and/or satellite connectivity to enable data transmission from remote field locations. In some embodiments, portable tracking devices 512a, 512b, and/or 512c include GPS receivers for real-time crew location tracking, cameras for capturing damage assessment imagery, and/or sensors for collecting environmental data at outage sites. In some embodiments, wireless network 504 serves as a central hub facilitating communication between computing device 502, OMS database 503, machine learning module 510, and/or portable tracking device(s) 512a, 512b, and/or 512c. In some embodiments, this connectivity allows real-time data exchange, allowing outage-specific and crew-specific data to be continuously updated and available for analysis. In some embodiments, wireless network 504 can include cellular networks, Wi-Fi access points, mesh networks, and/or satellite communication links to ensure connectivity across diverse geographic regions, including remote areas with limited infrastructure. In some embodiments, the portable tracking devices include a transceiving module.

For brevity, detailed descriptions of components common to both systems 300 and 500 will not be repeated here. Instead, the following focuses on additional components and functionalities illustrated in system 500.

In some embodiments, the algorithm can be broken down into several steps.

In some embodiments, Step 1 involves collecting and sorting information about an outage. In some embodiments, a real-time module consolidating the real-time data transmitted from portable tracking device(s) 512a, 512b, and/or 512c is integrated with the OMS or similar database 503 to receive and process incoming outage reports. In some embodiments, the real-time module processes incoming data streams from multiple portable tracking devices simultaneously, aggregating field reports, crew location updates, and site condition assessments into a unified data structure accessible by machine learning module 510. In some embodiments, the real-time module performs data validation and normalization to ensure consistency across reports from different crews and devices before integrating the data into the dispatch algorithm.

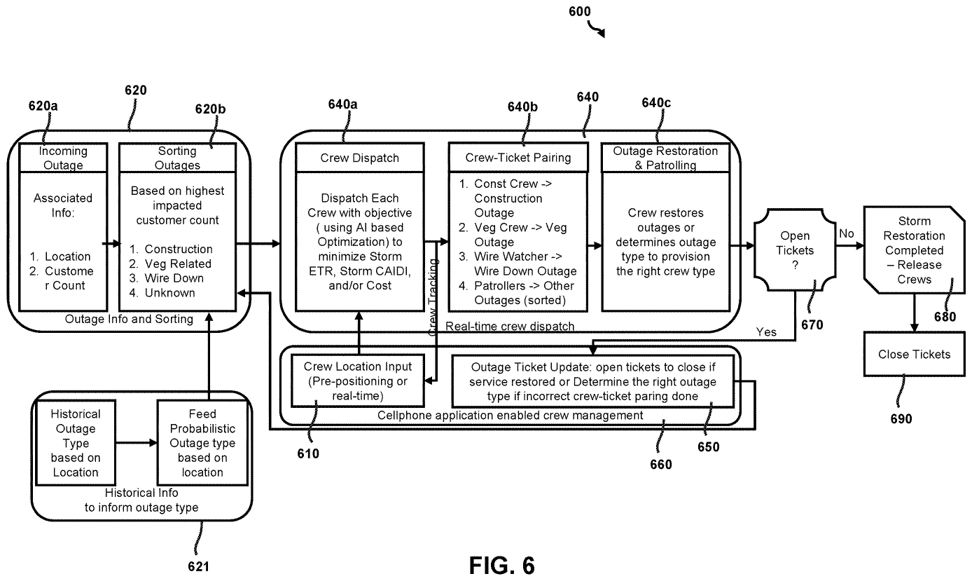

FIG. 6 illustrates real-time crew algorithm 600. In some embodiments of algorithm 600, outage entry and sorting 620 can include key attributes such as, but not limited to, outage location, affected customer count, outage type, estimated repair/restoration time (if available), and/or the time of the first report (block 620a). In some embodiments, the outage location can be specified using geographic coordinates, street addresses, or references to utility infrastructure identifiers such as pole numbers, transformer IDs, or circuit segment designations. In some embodiments, the affected customer count represents the number of service connections experiencing power interruption as a result of the outage event. In some embodiments, the outage type can be initially classified based on automated detection systems, customer reports, or preliminary assessments from field personnel.

In some embodiments, system 500 automatically classifies and/or organizes outages based on these attributes. In some embodiments, this can involve sorting outages by severity, customer impact, geographic region, and/or outage type (for example vegetation-related, equipment failure, weather-induced) (block 620b). In some embodiments, machine learning algorithms can be employed to refine classification by cross-referencing historical outage data with real-time reports. In some embodiments, the classification process utilizes pattern recognition techniques to identify correlations between current outage characteristics and historical outage events with similar attributes, enabling more accurate prediction of the underlying cause and required crew type. In some embodiments, the system can assign confidence scores to each classification, indicating the likelihood that the predicted outage type is accurate based on the available data.

In some embodiments, Step 2 involves prioritizing outage and crew assignments. In some embodiments, once outage data is collected, a prioritization algorithm can run to identify and rank outages based on customer impact. In some embodiments this is continuous. In some embodiments, the system dynamically updates this ranking such that the highest-impact outages (i.e., those affecting the most customers) are addressed first (block 620b). In some embodiments, the prioritization algorithm can incorporate additional factors beyond customer count, including the presence of critical facilities such as hospitals, emergency services, or water treatment plants within the affected area. In some embodiments, the algorithm can also consider the duration of the outage, applying increasing priority weights to outages that have remained unresolved for extended periods.

In some embodiments, to optimize, or at least improve, crew deployment, the system analyzes historical outage patterns, considering factors such as location-specific outage trends and typical restoration times (block 621). In some embodiments, the historical data informs outage type classification, allowing the system to efficiently pair each outage with the most suitable crew type (for example patrollers, wire watchers, vegetation crews, and/or construction crews). In some embodiments, by leveraging past outage resolutions and crew performance metrics, the system enhances decision-making, such that the correct resources are allocated to incidents for faster and more effective restoration. In some embodiments, the system maintains performance metrics for individual crews and crew types, including average restoration times by outage category, first-time fix rates, and geographic familiarity scores that indicate crew experience with specific service territories.

In some embodiments, Step 3 involves use of an AI-based crew dispatch algorithm. In some embodiments, the crew dispatch algorithm is a real-time AI-based process designed to efficiently assign available repair crews to outage tickets based on several factors, including, but not limited to, the probability of an outage type (e.g., transformer failure, downed lines, vegetation interference, etc.) (block 621); the number of affected customers per outage (block 620b); crew proximity to outage locations and estimated travel times; crew skill sets and equipment availability; and/or the objective (for example to minimize/reduce storm CAIDI (Customer Average Interruption Duration Index), to minimize/reduce total storm ETR (Estimated Time of Restoration), to minimize/reduce CMI (Customer Minutes Interrupted), and/or to reduce overall outage duration and associated costs) (block 640). In some embodiments, the algorithm balances these multiple factors using weighted optimization techniques that can be configured based on utility operational priorities and regulatory requirements.

In some embodiments, the algorithm dynamically assigns available crews to outage jobs (block 640b) by evaluating new information. In some embodiments, this information includes real-time outage reports, crew locations obtained from GPS-enabled portable tracking devices 512a, 512b, and/or 512c, current crew workload and estimated completion times for active assignments, and/or updated site conditions reported by field personnel (block 610). In some embodiments, new information is evaluated continuously, with the algorithm recalculating optimal crew assignments at configurable intervals or upon receipt of significant updates such as new outage reports, crew status changes, or revised outage classifications. In some embodiments, the continuous evaluation enables the system to adapt to rapidly changing conditions during storm events, reallocating resources as the situation evolves to maintain optimal restoration efficiency.

In some embodiments, the system automatically takes remedial actions based on the AI dispatch algorithm outputs without requiring human intervention for each dispatch decision. In some embodiments, when the algorithm identifies an outage ticket requiring attention, the system automatically dispatches the appropriate crew type to the outage location, automatically updates the crew's assignment queue on their portable tracking device, and/or automatically adjusts the assignments of other crews to optimize overall restoration efficiency. In some embodiments, when field personnel report updated site conditions through their portable tracking devices, the system automatically reclassifies the outage type, automatically reassigns crews if the original assignment was incorrect, and automatically updates estimated restoration times in real time. In some embodiments, this automatic remediation capability enables the system to respond to changing field conditions without the delays inherent in manual dispatcher review, similar to how network security systems automatically drop malicious packets and block suspicious traffic sources without waiting for administrator intervention. In some embodiments, the automatic dispatch and reassignment functionality represents a technical improvement to utility outage management infrastructure by enabling real-time, adaptive resource allocation that continuously optimizes crew deployment as the outage situation evolves.

An example of crew dispatch computation is provided below.

### Given:

1. A set of n jobs (outage tickets):
{C_1, C_2, . . . , C_n}

Each outage ticket corresponds to a reported power outage, including location, severity, estimated repair time, and number of affected customers.

2. A set of m crews:
{S₁, S₂, . . . , S_{m}})
   where m represents the number of available crews that can be dispatched to attend the jobs/outage tickets.

3. A travel time matrix:

$$T = [ {t}_{ij} ]$$

where tᵢⱼ represents the estimated travel time from outage Cᵢ to outage Cⱼ

4. A starting depot or initial location for each crew:

It is assumed that each crew begins and ends at a designated location (e.g., an operations center or staging area).

If the objective is to reduce the total restoration time, which includes the total time traveled by all crews combined, while ensuring that each job associated with an outage ticket is visited exactly once by exactly one crew.

The objective function is defined as:

$$Minimize {\sum }_{k = 1}^{m} {\sum }_{i \neq j} {P}_{k , i , j} \cdot {x}_{ij}^{k} \cdot {Cust}_{i}$$

where tₙ=Time at the point of dispatch;
taᵢ=Time at which outage ticket i was reported.
trᵢ=Expected restoration time for outage i.
Custᵢ=Number of customers affected by outage i; and

$${x}_{ij}^{k} = Binary decision variable indicating whether crew k moves from$$

outage i to outage j.

$${P}_{k , i , j} = ( {t}_{n} - {ta}_{p} ) + {\sum }_{p = 1}^{i} 〚 [ + {tr}_{p} + {t}_{p , p + 1} 〛 ]$$

The function prioritizes high-impact outages while minimizing, or at least reducing total restoration time.

### Decision Variables

1. Route selection

$${x}_{ij}^{k} ∈ \{ 0 , 1 \}$$

where

$${x}_{ij}^{k} = 1$$

if crew k travels from outage Cᵢ to Cⱼ, otherwise 0.

2. Job Assignment

$${y}_{i}^{k} ∈ \{ 0 , 1 \}$$

where

$${y}_{ij}^{k} = 1$$

if outage Cᵢ is assigned to crew k, otherwise 0.

### Constraints

1. Each location associated with an outage ticket is visited exactly once:

$${\sum }_{k = 1}^{m} {\sum }_{j \neq i} {x}_{ij}^{k} = 1 , ∀ i ∈ \{ 1 , 2 , … , n \}$$

This ensures that each outage ticket is visited once by one crew.

2. Each crew departs from and returns to its starting location:

$${\sum }_{j \neq 0} {x}_{0 j}^{k} = 1 , {\sum }_{i \neq 0} {x}_{i 0}^{k} = 1 , ∀ k ∈ \{ 1 , 2 , … , m \}$$

Each crew must leave their starting point and return after completing assigned jobs (initial location being 0).

3. Flow Continuity (No Skipped Jobs):

$${\sum }_{j \neq i} {x}_{ij}^{k} - {\sum }_{j \neq i} {x}_{ji}^{k} = 0 , ∀ i ∈ \{ 1 , 2 , … , n \} , ∀ k ∈ \{ 1 , 2 , … , m \}$$

This ensures that if a crew must continue to the next job Cⱼ after completing job Cᵢ or return to the depot, ensuring no job is skipped.

4. Job Assignment to a Crew:

$${y}_{i}^{k} = {\sum }_{j \neq i} {x}_{ij}^{k} , ∀ i ∈ \{ 1 , 2 , … , n \} , ∀ k ∈ \{ 1 , 2 , … , m \}$$

Each job must be assigned to exactly one crew.

In some embodiments, Step 4 involves dispatching crews based on the outage type probability. In some embodiments, once the outage prioritization algorithm has identified the most critical tickets based on customer impact and historical outage patterns, the system proceeds with deploying crew to restore the outage (block 640c).

In some embodiments, construction and repair crews can be dispatched to outage locations where the probability of requiring their services exceeds a predetermined threshold. In some embodiments, this threshold is determined based on historical outage data, which includes factors such as outage type, location, and prior restoration efforts in similar conditions. In some embodiments, the machine learning model continuously refines these probability estimates using historical outage data collected from the past event and real-time outage information.

In some embodiments, for remaining outages that are less likely to require construction/repair work, the system can allocate vegetation/tree cleanup crews based on a separate AI-driven probability model. In some embodiments, the model evaluates whether fallen trees, debris, or vegetation interference are likely to be the primary cause of the outage based on geographic, environmental, and/or historical outage data for that location.

In some embodiments, if the probability models indicate low confidence in requiring either a construction or vegetation crew, the system assigns patrollers to assess the site conditions. In some embodiments, patrollers are responsible for physically inspecting outage locations to determine the actual cause of the outage.

In some embodiments, the patroller assignment algorithm prioritizes outages that have the highest customer count but lack a definitive crew type assignment. In some embodiments, the algorithm/system ensures that high-impact outages are investigated promptly. In some embodiments, once a patroller completes an inspection, they can update the outage details through the system, specifying whether a construction or vegetation crew is required. In some embodiments, this updated data is integrated into the next dispatch cycle, ensuring that the correct resources are deployed as quickly as possible.

In some embodiments, Step 5 involves utilizing real-time updates and re-optimization of the algorithm. In some embodiments, as crews including, but not limited to, vegetation crews, construction crews, and/or specialized teams like wire watchers arrive at their assigned outage sites, they can continuously assess the accuracy of the initial outage classification.

In some embodiments, if a crew determines that an incorrect crew type was initially assigned to a ticket (e.g., a vegetation crew was dispatched when a construction crew was actually needed), they can update the outage classification using a mobile application in the portable tracking device integrated with the utility's outage management system (block 610).

In some embodiments, once this information is updated, the crew dispatch algorithm automatically reruns, reassigning crews as necessary to ensure that appropriate personnel are sent to each site (blocks 640a, 640b).

In some embodiments, the adaptive dispatching approach allows the system to dynamically respond to unexpected site conditions, reducing delays caused by misallocated resources and improves the overall restoration timeline.

In some embodiments, Step 6 involves continuously monitoring and releasing crews. In some embodiments, the restoration process operates as a continuous feedback loop until all outages are resolved.

In some embodiments, if new outage tickets are created (e.g., additional outages reported as the storm progresses), the system repeats the prioritization, crew assignment, and dispatch cycle to integrate these new outages into the workflow.

In some embodiments, if outage tickets remain open (block 670), the dispatch algorithm continuously refines crew assignments based on evolving conditions, crew availability, and/or site updates provided by patrollers and active crews (block 650).

In some embodiments, as the number of unresolved outages gradually decreases, the utility can begin releasing surplus crews who are no longer needed (block 680). In some embodiments, when the restoration is completed, the crew can close the outage ticket (block 690). In some embodiments, this can be done in stages to ensure that remaining outages are adequately staffed while minimizing, or at least reducing, operational costs.

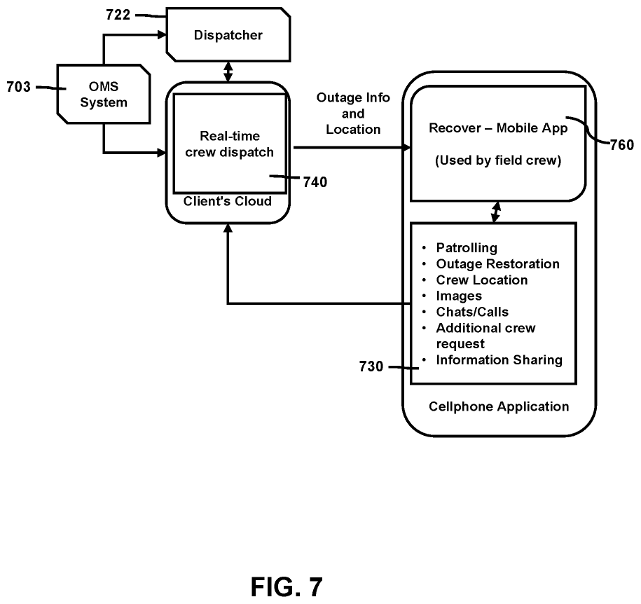

In some embodiments an application and/or user interface application 660 or 760 as illustrated in FIG. 6 and FIG. 7 can be executed on one or more of portable tracking devices 512a, portable tracking devices 512b, or portable tracking devices 512c (FIG. 5). In some embodiments application 660 and/or user interface application 760 interfaces portable tracking devices 512a, portable tracking devices 512b, and/or portable tracking devices 512c with computing device 502, providing an interactive communication platform for crews to report real-time outage data back to dispatching center. In some embodiments this enables coordination between field crews and the AI-powered system, ensuring up-to-date decision-making for efficient outage restoration.

In some embodiments the interactive application plays a role in real-time data exchange, keeping the AI-powered crew dispatch algorithm adaptive to site conditions. In some embodiments user interface application 760 follows a structured sequence of instructions to ensure efficient outage response while allowing adaptability to changing conditions. In some embodiments the instructions can include:

### Monitoring and Validation

As illustrated in FIGS. 4-7, the process can begin with monitoring and validation, where human dispatcher 522 and/or 722 oversees database 503 and/or OMS 703 to confirm the AI-based outage classification and prioritization and/or prioritization are accurate. In some embodiments, once validated, automated dispatch system 400 processes outage data and assigns locations to available crews, such as crew 408a based on factors such as travel time, crew specialization, and/or outage severity. In some embodiments, these assignments are then relayed through user interface application 760 in a device, such as portable tracking device 512a, providing crews with real-time access to their assigned outage tickets.

### Crew Reporting and Data Sharing

In some embodiments, upon reaching an outage site, crews 408a, 408b, and/or 408c, utilize the crew reporting and data-sharing feature of user interface application 760 to log field information. In some embodiments, the crews can submit real-time updates as shown in block 730 such as damage assessment photos, estimated repair times, required equipment, and/or other unexpected challenges encountered. In some embodiments, these updates are transmitted to the network-hosted (such as a cloud based) system, where an AI-based crew algorithm processes these updates in real time.

In some embodiments, by continuously analyzing crew-reported data, system 400 dynamically re-evaluates outage priorities, adjusts estimated restoration times, and/or reallocates crews if necessary. In some embodiments, if a particular outage requires additional resources or specialized expertise, the algorithm can redirect nearby available crews or notify dispatchers to intervene. In some embodiments, this feedback loop allows restoration efforts to remain adaptive, minimizes or at least reduces delays and improves overall efficiency.

### Dispatcher Intervention and Crew Flexibility

In some embodiments, while the AI optimizes, or at least improves, crew dispatch (i.e., the real-time assignment and deployment of crews to specific outage locations based on prioritization, crew availability, and/or predicted outage types) autonomously, dispatcher control remains integral to the system, to intervene with the real-time crew dispatch when necessary. In some embodiments, dispatchers can manually override assignments in response to urgent developments, such as, but not limited to, high-priority outages, safety concerns, and/or resource limitations. In some embodiments, this allows human expertise to remain a factor in decision-making. At the same time, crew flexibility allows field teams to adjust their queues dynamically. In some embodiments, rather than adhering strictly to pre-assigned routes, crews can respond to nearby outages based on urgency, optimizing restoration efforts in real time.

### AI-Based Re-Optimization

In some embodiments, the AI-based re-optimization process results in continuous system improvement. In some embodiments, the AI dynamically integrates incoming field data, continuously updating OMS 703 with real-time outage information (block 730). In some embodiments, the AI fetches data from block 730 and/or block 740 and processes this data to re-prioritize crew-type ticket assignments based on the dispatcher's judgment (block 722) as the situation evolves. In some embodiments, the re-optimization process leverages the machine learning models described herein, including regression analysis, Chebyshev approximation, and DBSCAN clustering, to recalculate optimal crew assignments based on the updated field conditions. In some embodiments, the re-optimization algorithm evaluates changes in outage severity, crew availability, and estimated restoration times to determine whether reassignment of crews would improve overall restoration efficiency. In some embodiments, the system compares the projected CMI and CH values under the current assignment against alternative assignment configurations to identify opportunities for improvement. In some embodiments, the assigned crew type then proceeds accordingly with the reassignment, receiving updated dispatch instructions through user interface application 760 on their portable tracking devices 512a, 512b, and/or 512c. In some embodiments, the re-optimization process can be triggered automatically upon receipt of significant field updates, at configurable time intervals, or upon manual request by a dispatcher. In some embodiments, this adaptive mechanism helps restoration efforts remain efficient, responsive, and aligned with real-world conditions, enabling the system to converge toward optimal resource allocation as more accurate information becomes available from the field.

The neural networks herein, in embodiments, refer to an artificial intelligence (AI) based neural network, including machine learning (ML) or deep learning (DL) models. In some embodiments, the neural networks can include supervised learning models trained on labeled historical outage data to predict outage types, restoration times, and crew requirements. In some embodiments, the neural networks can include regression models for estimating continuous values such as CMI and crew hours, classification models for categorizing outage types, and clustering algorithms such as DBSCAN for identifying patterns in outage distributions across geographical regions. In some embodiments, the machine learning models can include ensemble methods that combine multiple algorithms, such as the combination of regression analysis, Chebyshev approximation, and DBSCAN clustering described herein, to improve prediction accuracy by averaging results from different computational approaches. In some embodiments, the deep learning models can include feedforward neural networks, recurrent neural networks for processing sequential outage data, and/or convolutional neural networks for analyzing spatial patterns in outage distributions. In some embodiments, the neural networks can be trained using backpropagation algorithms with optimization techniques such as stochastic gradient descent or Adam optimization. In some embodiments, the neural networks can be periodically retrained using updated historical outage data and post-storm analytics to improve prediction accuracy over time. In some embodiments, the neural networks can be deployed on server devices, cloud computing platforms, and/or edge computing devices to enable both centralized processing and distributed inference capabilities.

In some embodiments, a number of implementations have been described. Nevertheless, it will be understood that various modifications can be made without departing from the spirit and scope of the disclosure. Accordingly, other implementations are within the scope of the following claims.

Computer readable medium having program code recorded thereon for execution on a computer of the methods are disclosed above.

Throughout the description, specific details are set forth to provide a more thorough understanding of the inventions. However, the disclosed methods and systems can be practiced without these particulars. In other instances, well-known elements have not been shown or described in detail to avoid unnecessarily obscuring the inventions. Accordingly, the specification and drawings are to be regarded in an illustrative, rather than a restrictive sense.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or variants thereof, mean connection or coupling, either direct or indirect, permanent, or non-permanent, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Thus, for example, a reference to “a linker” is a reference to one or more linkers and equivalents thereof known to those skilled in the art. Similarly, the phrase “and/or” is used to indicate one or both stated cases can occur, for example, A and/or B includes (A and B) and (A or B).

Unless defined otherwise, technical, and scientific terms used herein have the same meanings as commonly understood by one of ordinary skill in the art to which the process pertains. The embodiments of the process and the various features and advantageous details thereof are explained more fully with reference to the non-limiting embodiments and/or detailed in the following description. It should be noted that features of one embodiment can be employed with other embodiments as the skilled artisan would recognize, even if not explicitly stated herein.

Any numerical value ranges recited herein include all values from the lower value to the upper value in increments of one unit, provided that there is a separation of at least two units between any lower value and any higher value. As an example, if it is stated that the concentration of a component or value of a process variable such as, for example, size, angle size, pressure, time and the like, is, for example, from 1 to 98, specifically from 20 to 80, more specifically from 30 to 70, it is intended that values such as 15 to 85, 22 to 68, 43 to 51, 30 to 32, and the like, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value are to be treated in a similar manner.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of these inventions. These inventions includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present inventions have been shown and described, it will be understood that the inventions are not limited thereto since modifications can be made without departing from the scope of the present disclosure, particularly in light of the foregoing teachings.

What is claimed is:

1. A system for determining a crew preplacement for a crew in response to an outage ticket based on an objective, the system comprising:
a computing system comprising:
a non-transitory memory storing a set of executable instructions; and
a processor coupled to said non-transitory memory, wherein said processor executes said set of executable instructions to determine said crew preplacement by
acquiring and analyzing historical outage data associated with a geographical region and an outage type;
computing a machine learning-based metric and an outage prediction associated with said geographical region;
generating an initial crew preplacement suggestion based on said machine learning-based metric and said outage prediction associated with said geographical region;
acquiring a first user input accepting said initial crew preplacement suggestion; and
terminating the crew preplacement if acceptance of said initial crew preplacement suggestion is acquired.

2. The system according to claim 1, further comprising:
acquiring a second user input revising said objective to create a revised objective if non-acceptance is acquired for said initial crew preplacement suggestion;
computing a second crew preplacement suggestion based on the revised objective;
acquiring a third user input accepting said second crew preplacement suggestion; and
terminating the crew preplacement if acceptance of said second crew preplacement suggestion is acquired.

3. The system according to claim 1, wherein said processor further:
determines restoration time associated with said outage type;
computes a ratio of vegetation-related outages to non-vegetation-related outages for said outage type associated with said geographical region;
computes a ratio of wire-down events to total outages for said outage type associated with said geographical region; and
computes an average restoration time for said outage ticket based on said historical outage data associated with said geographical region.

4. The system according of claim 1, wherein said objective is an estimated time of restoration.

5. The system according to claim 1 wherein said historical outage data includes a historical outage location, a historical outage type, a historical restoration time, a historical ticket data, and/or a historical crew-specified feature.

6. The system according to claim 5 wherein said historical crew-specified feature includes a crew type, a crew location, and/or a crew staffing protocol.

7. A system for determining a real-time crew dispatch for a crew in response to an outage ticket, the system comprising:
a portable tracking device carried by said crew,
wherein said portable tracking device comprises a wireless communication interface configured to transmit outage data;
a computing system comprising:
a non-transitory memory storing a set of executable instructions;
a transceiving module connecting with said wireless communication interface in said portable tracking device; and
a processor coupled to said transceiving module and said non-transitory memory, wherein said processor, executes said set of executable instructions determining said real-time crew dispatch by:
acquiring and analyzing an outage data associated said outage ticket, wherein said outage data includes an outage location and a customer count;
sorting and prioritizing said outage ticket based on said customer count;
acquiring a historical outage data to calculate a probability of an outage type associated with said outage location associated with said outage ticket;
using a machine learning model to iteratively assign a crew type with said outage ticket based on a prioritization and an objective;
dispatching said crew type based on the probability of requiring said crew type;
comparing the probability of requiring said crew type with a first predetermined threshold; and
assigning said crew type to said outage location if the probability of requiring said crew type is greater than said first predetermined threshold.

8. The system according to claim 7, wherein said outage data includes said probability of the outage type, a restoration time, said crew type and/or a crew location associated with said outage ticket.

9. The system according to claim 7, wherein said historical outage data includes a historical outage location, a historical outage type, a historical restoration time and/or the probability of requiring said crew type.

10. The system according to claim 7, wherein the first predetermined threshold is based on a historical outage type associated with said outage location defined in said historical outage data.

11. A user interface application executed on the portable tracking device that communicates within the computing system according of claim 7 configured to:
receive a crew-outage ticket assignment derived from said computing system;
acquire and assess a collected outage data collected on site from said crew;
transmit said collected outage data to said computing system for further processing by a dispatcher; and
adjust wherein said crew is assigned based on said collected outage data.

12. A method for determining preplacement of a crew in response to an outage ticket based on an objective, the method comprising:
acquiring and analyzing an amount of historical outage data associated with a geographical region and an outage type;
computing a machine learning-based metric and an outage prediction associated with said geographical region;
generating an initial crew preplacement suggestion based on said machine learning-based metric and said outage prediction; and
acquiring a first user input accepting said initial crew preplacement suggestion.

13. The method according to claim 12, further comprising:
determining restoration time for said outage ticket associated with said outage type;
computing a ratio of vegetation-related outages to non-vegetation-related outages for said outage type associated with said geographical region;
computing a ratio of wire-down events to total outages for said outage type associated with said geographical region; and
computing an average restoration time for said outage ticket based on the historical outage data associated with said geographical region.

14. The method according to claim 12, further comprising:
acquiring a second user input revising said objective to create a revise objective if non-acceptance is acquired for said initial crew preplacement suggestion;
computing a second crew preplacement suggestion based on the revised objective;
acquiring a third user input accepting said second crew preplacement suggestion; and
terminating the initial crew preplacement suggestion if acceptance of said second crew preplacement suggestion is acquired.

15. The method according to claim 12, wherein said objective is an estimated time of restoration.

16. The method according to claim 12, wherein said historical outage data includes a historical outage location, a historical outage type, a historical restoration time, a historical ticket data, and/or a historical crew-specified feature.

17. The method according to claim 16, wherein said historical crew-specified feature includes a crew type, a crew location, and/or a crew staffing protocol.

18. The method according to claim 12, further comprising:
sorting and prioritizing said outage ticket based on a customer count included in said historical outage data;
calculating a probability of said outage type associated with an outage location associated with said outage ticket;
using a machine learning model to iteratively assign a crew type with said outage ticket based on a prioritization and said objective;
dispatching said crew type based on the probability of requiring said crew type;
comparing the probability of requiring said crew type with a first predetermined threshold; and
assigning said crew type to said outage location if the probability of requiring said crew type is greater than said first predetermined threshold.

19. The method according to claim 18, further comprising:
dispatching a patroller to verify site condition associated with said outage location if the probability of requiring said crew type is below said first predetermined threshold.

20. The method according to claim 18, further comprising:
determining if assigning said crew type with said outage ticket is correct or incorrect;
transmitting an updated outage data to a computing system via a portable tracking device if said assigning is incorrect; and
repeating said sorting and prioritizing, said calculating, said using said machine learning model, said dispatching, said comparing, and said assigning with said updated outage data.
